(19) United States
(12) Patent Application Publication
(10) Pub. No.: US 2011/0114267 A1
(43) Pub. Date: May 19, 2011

(54) STRIP DISPENSER

(76) Inventor: Andre THEVENAU, Tamarin Bay (MU)

(21) Appl. No.: 12/620,673

(22) Filed: Nov. 18, 2009

(51) Int. Cl. B29C 65/52

(52) U.S. Cl. 156/538

(57) ABSTRACT

A strip dispenser, and more specifically a dispenser for industrial or medical applications which includes a product for coating or impregnating the strip. This product is, depending on the use, a disinfectant, a lubricant and even be an adhesive in certain circumstances. The dispenser is in the form of a spool around which the strip is wound and the spool is locatable in a zone containing a product for application to the strip while it is being pulled through a slot in the zone.

### FIELD OF THE INVENTION

This invention relates to a strip dispenser for industrial, medical and other applications; and in particular to a device for application of an impregnated or coated strip to a surface.

### BACKGROUND OF THE INVENTION

The application of a silicone or bitumen impregnated strip for sealing and other purposes is generally a messy affair or involves complicated smearing or otherwise coating the strip before application. In the case of a medical bandage, the sterility thereof can be seriously compromised.

Certain pre-coated strips are known that have a cover strip to protect the coating until used, but the removal of the cover strip is often difficult and may result in loss of the coating.

Dispensers for bandages are known—for example in U.S. Pat. No. 5,065,894 (Garland) a bandage is covered on both sides with paper layers and delivered into an accessible outlet of the dispenser by means of opposed press rollers. Two stripping rollers remove the layers thereby freeing the bandage for use. This involves a number of moving parts and is clumsy to use—especially for hand-held applications.

In U.S. Pat. No. 4,993,586 (Taulbee) a length of bandage is folded as a zig zag inside a dispenser with an opening. The bandage has a layer of adhesive wrapped in a protective coating and although this is simpler than Garland it is nevertheless also clumsy.

Many other similar devices were found in an Internet search but none were found that enjoyed the simplicity of the present invention.

It is an object of the present invention to provide a dispenser that is simple and inexpensive to manufacture and easy to use without compromising the constitution of a prepared strip.

### THE INVENTION

According to the invention a dispenser includes a housing for a spool adapted to receive a rolled strip, and is journalled for rotation in a zone for a coating for the strip, the zone including a slot for access to the coated strip for removal of selected lengths thereof,

The zone may take the form of a reservoir for the coating.

The strip may be a medical bandage that is coated with an adhesive or a disinfectant or the like solution, suspension or other form—for example a gel for orthopedic use, but it will be appreciated that it may be a dry strip in the absence of an impregnant, coating or the like.

The strip may be of woven on non-woven textile and the coating may be a silicone, bitumen or the like for sealing and other purposes.

The dispenser of the invention may include a spring loaded arrangement adapted to be released when required by a push button or the like so that is can be used to dispense the strip with one hand, the other hand guiding and placing the strip in the desired position.

The dispenser may be sealed with tab or the like covering the slot.

In the preferred form the end of the strip is attached to the tab so that when it is removed immediate access to the strip is ensured. The tab may be adapted to provide an air tight seal to prevent leakages and/or evaporation.

In another form of the invention the dispenser may include flexible areas on the ends where the spool is in contact or near the walls of the dispenser. In this form the thumb and index finger of a user may be placed on the flexible areas and exert pressure on the spool to control the rate at which the strip is unrolled.

In yet another form of the invention the slot includes a blade or the like to assist in cutting the strip.

Many various sizes and arrangements of dispenser may be used for many different applications depending on the nature of the strip and of the product and of the required use. Thus, a simple cartridge may be provided for quick household repairs.

### EMBODIMENT OF THE INVENTION

An embodiment of the invention is described below with reference to the accompanying drawings in which:

FIG. 1 is an exploded cross-sectional view of a dispenser incorporating an example of the invention;

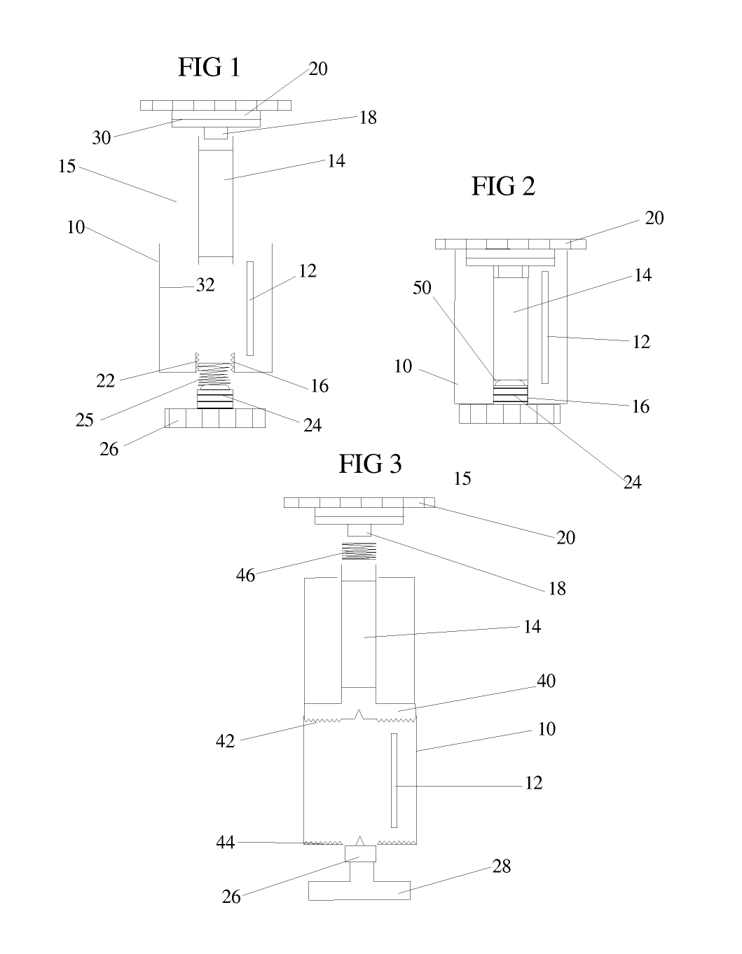

FIG. 2 is a similar view of the assembled dispenser;

FIG. 3 is an exploded cross-section view of an alternative form of the invention;

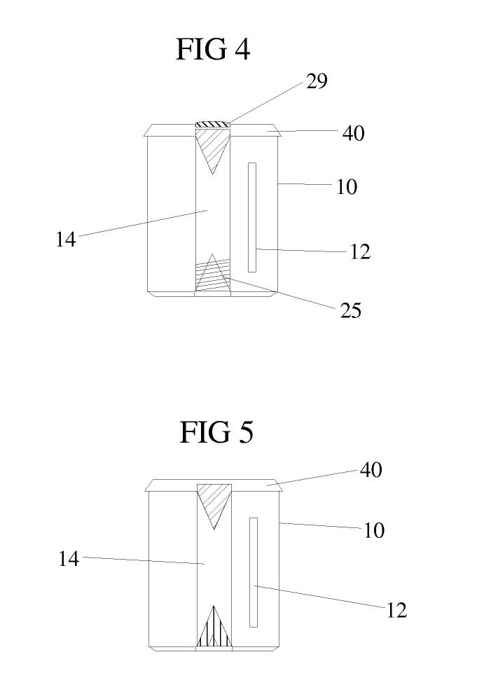

FIG. 4 is a sectional side view of a further alternative form of the invention

FIG. 5 is a similar of a simple form of the invention

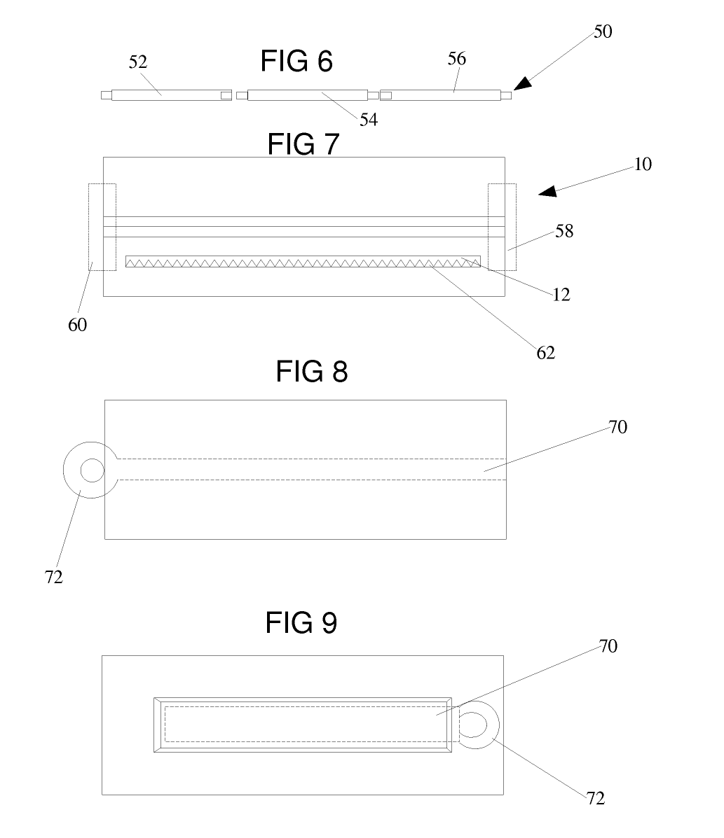

FIG. 6 is a side view of a series of spindles;

FIG. 7 is a similar view of an alternative form of the invention; and

FIGS. 8 and 9 are side views of the spool including a sealing tab.

In FIGS. 1 and 2 a dispenser includes a housing 10 having a slot 12 for removal of a strip 15 that is wound on a spool 14. The latter is rotatable on a vertical ring 16 and the downwardly extending spindle 18 of a cap 20. The ring is internally threaded at 22 to receive complementary external threading 24 of a knurled screw 26. A compression spring 25 is located on the threading 24.

The cap 20 is also knurled and clips into the top opening of housing by means of corresponding formations 30, 32.

In FIG. 3 similar items are similarly referenced. The spool includes a collar 40 that includes teeth 42. These teeth engage with teeth 44 in the bottom of housing 10 for locking the spool in its inoperative condition. When a strip (not shown) wound on the spool is pulled through the slot 12, the shaft rises due to the engagement of the teeth 42, 44 due to the compression spring 46. When the pulling action is stopped the spring causes the teeth of the shaft to re-engage.

Referring to FIG. 4 a flexible button 29 is provided that when pressed allows the spool freely to rotate and dispense the strip until the button is released when the action of the spring 25 causes the spool to be locked again. In FIG. 5 the spring and button are omitted, the spindle being freely rotatable

Turning to FIG. 6, a spool comprises a series of independent shafts 52, 54 and 56 that are interconnected and are adapted to turn independently of one another. This embodiment may be useful in cases where different types of strip are to be used on the same spool.

FIG. 7 includes two flexible areas 58 and 60 for pressure to be applied by the index finger and the thumb of the user. Depending on the pressure exerted on the spool the user can control the rate at which the strip is being dispensed.

In this drawing the slot 12 is adapted to include a toothed blade 62 to assist in cutting the strip when required. The blade may be provided in the other forms of the invention as described above.

FIGS. 8 and 9 show a tab 70 with a ring formation 72 at one end to make gripping the tab easier. The tab is used to seal the spool to prevent leakage or evaporation of any products, and to ensure the sterility of the strip where so desired.

1. A strip dispenser including a spool carrying a strip in rolled form, and a zone to accommodate a product for application to the strip, and the zone adapted to contain or receive the spool; and having a slot for removal of the strip bearing the product

2. The strip dispenser according to claim 1 in which spool and zone are slidable in relation to each other against compressive spring.

3. A strip dispenser including a spool carrying a strip in rolled form, and a zone to accommodate a product for application to the strip, the spool being spring biased in the zone to resist rotation of the spool when the strip is pulled through the slot, and includes optional means to overcome the resistance of the spring.

4. The strip dispenser according to claim 3 in which the means includes a thumb button adapted to diminish the spring means.
